(19) United States
(12) Patent Application Publication
(10) Pub. No.: US 2011/0184701 A1
(43) Pub. Date: Jul. 28, 2011

(54) Pitot Tube Diagnostic System

(75) Inventors: Bradley Louis ORME, Knoxville, TN (US); Hashem M. Hashemian, Knoxville, TN (US); Ryan Douglas O'Hagan, Knoxville, TN (US)

(73) Assignee: Analysis and Measurement Services Corporation, Knoxville, TN (US)

(21) Appl. No.: 13/015,783

(22) Filed: Jan. 28, 2011

Related U.S. Application Data
(60) Provisional application No. 61/299,107, filed on Jan. 28, 2010.

(51) Int. Cl. G01F 1/46; G06F 15/00

(52) U.S. Cl. 702/183

(57) ABSTRACT

A pitot tube diagnostic system and method for determining the health of a pitot tube is disclosed. The pitot tube diagnostic system is configured to be temporarily connectable to or permanently installable in an airplane's pitot-static system, which allows the pitot tube diagnostic system to be utilized during pre-flight inspections and/or in-flight conditions. The pitot tube diagnostic system is in electrical communication with the pitot-static system for acquisition of output signals and analysis thereof. Thus, the pitot-static diagnostic system is able to diagnose anomalies in the pitot-static systems that are representative of the overall health and efficiency of the pitot-static system.

### CROSS-REFERENCE TO RELATED APPLICATIONS

This application claims the benefit of U.S. Provisional Application No. 61/299,107, filed Jan. 28, 2010.

### STATEMENT REGARDING FEDERALLY SPONSORED RESEARCH OR DEVELOPMENT

Not applicable

### BACKGROUND OF THE INVENTION

1. Field of Invention

The present invention relates to a diagnostic system for pitot-static systems in aircraft. More specifically, the present invention relates to a diagnostic system for in-flight and pre-flight detection of anomalies in pitot-static system readings which are indicative of the health of the pitot-static system.

2. Background of Relevant Art

The health and integrity of aircraft sensors and instruments play a critical role in aviation safety. In the case of a pitot-static system, the health and integrity of sensors and instruments are often critical to a successful flight. The pitot-static system is a pressure-sensitive system that is used to determine specific details about the aircrafts flight. FIG. 1 illustrates a conventional pitot-static system 10 that includes a pitot tube 12, pitot-static instruments 14, and a static port 16. As depicted, the pitot tube 12 and static port 16 are essentially pressure sensors which provide data to the pitot-static instruments 14 to generate indications of the aircraft's airspeed, vertical speed, and altitude. These sensors commonly experience problems with blockages, icing, and moisture which contribute to inaccurate readings in the pitot-static instruments 14. Inaccurate readings on the pitot-static instruments 14 can lead to erroneous decisions which result in serious, if not fatal, consequences.

Many aircraft crashes in recent years have been linked to failures in the pitot-static system 10. These failures include loss of airspeed indication and airspeed anomalies that have resulted from water contamination of the pitot tube, icing, tape covering the static ports 16, and pitot tube 12 blockages. Recently, the Federal Aviation Administration has issued an order stating that all U.S. Airlines operating Airbus A330s and A340s must replace at least two of the three pitot tube 12 sensors on each plane because of the safety concerns of pitot tube 12 blockages. Accordingly, the detection of failures in the pitot tube 12 readings is of great importance to aviation safety.

### SUMMARY OF THE INVENTION

A pitot tube diagnostic system and method for determining the health of a pitot tube is described herein. The pitot tube diagnostic system is temporarily connectable to or permanently installable in an airplane's pitot-static system, which allows the pitot tube diagnostic system to be utilized during pre-flight inspections and during in-flight conditions, respectfully. The pitot tube diagnostic system includes an acquisition unit in communication with a processing unit. The acquisition unit is configured to be placed in electrical communication with the pitot-static system for the aircraft. The acquisition unit samples output signals from the pitot-static system and produces sampled signals. The processing unit receives the sampled signals from the acquisition unit and filters the sampled signals to isolate the dynamic (AC) component representative of the process fluctuations or “noise.” The pitot tube diagnostic system analyzes the dynamic component using the “noise analysis” technique, power spectral density (PSD) curves, or amplitude probability density (APD) plots. This analysis allows the pitot tube diagnostic system to determine whether there are potential problems with the instruments or sensors, blockage or damage to the pitot-static system, or the degradation of the pitot-static system.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is an illustration of a conventional pitot-static system used in aircraft;

FIG. 2 is a block diagram of a pitot tube diagnostic system according to an example embodiment of the present general inventive concept;

FIG. 3 is a block diagram of a pitot-static system and the respective input signal and output signal according to an example embodiment of the present general inventive concept;

FIG. 4 is a representation of an electrical signal produced by the pitot-static system including a static component and a dynamic component according to an example embodiment of the present general inventive concept;

FIG. 5 is an illustration of a theoretical PSD Curve with break frequency according to an example embodiment of the present general inventive concept;

FIG. 6 is an illustration of a PSD Curve showing resonance in the signal according to an example embodiment of the present general inventive concept;

FIG. 7 is an illustration of the noise analysis results for a clear pitot tube and a blocked pitot tube according to an example embodiment of the present general inventive concept;

FIG. 8a is an illustration of APD plot for determining data quality and sensor performance according to an example embodiment of the present general inventive concept;

FIG. 8b is an illustration of APD plots for determining data quality and sensor performance according to an example embodiment of the present general inventive concept; and

FIG. 9 is a block diagram of one embodiment of a system for performing pre-flight testing of pitot tubes according to an example embodiment of the present general inventive concept.

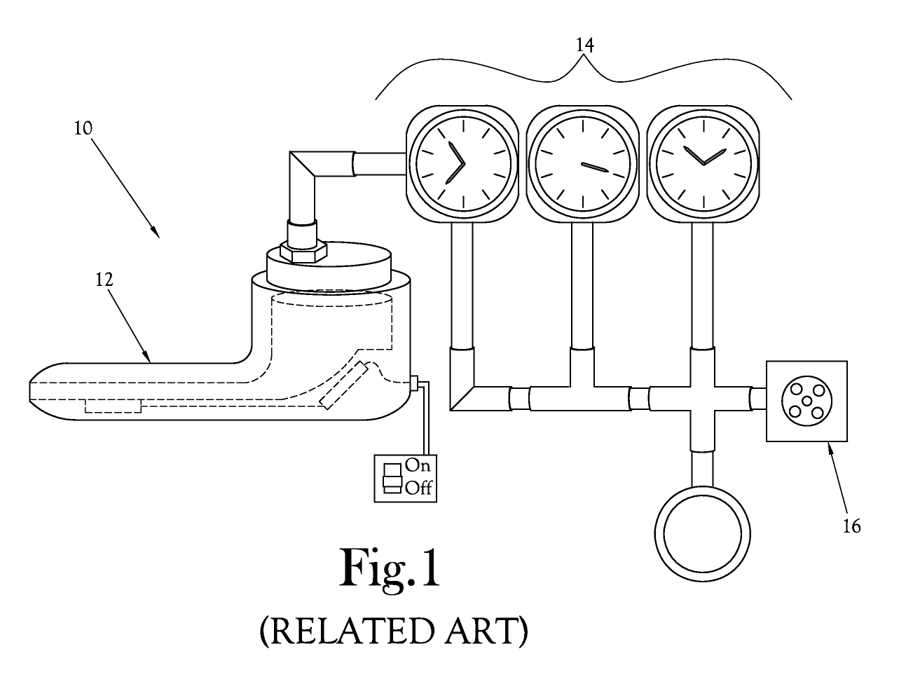

### DETAILED DESCRIPTION OF THE INVENTION

A pitot tube diagnostic system and method for determining the health of a pitot tube is described in detail herein and shown in the accompanying figures. The pitot tube diagnostic system is configured to be temporarily connectable to or permanently installable in an airplane's pitot-static system, which allows the pitot tube diagnostic system to be utilized during pre-flight inspections and/or in-flight conditions. The pitot tube diagnostic system is in electrical communication with the pitot-static system for acquisition of output signals and analysis thereof. Thus, the pitot-static diagnostic system is able to diagnose anomalies in the pitot-static systems that are representative of the overall health and efficiency of the pitot-static system.

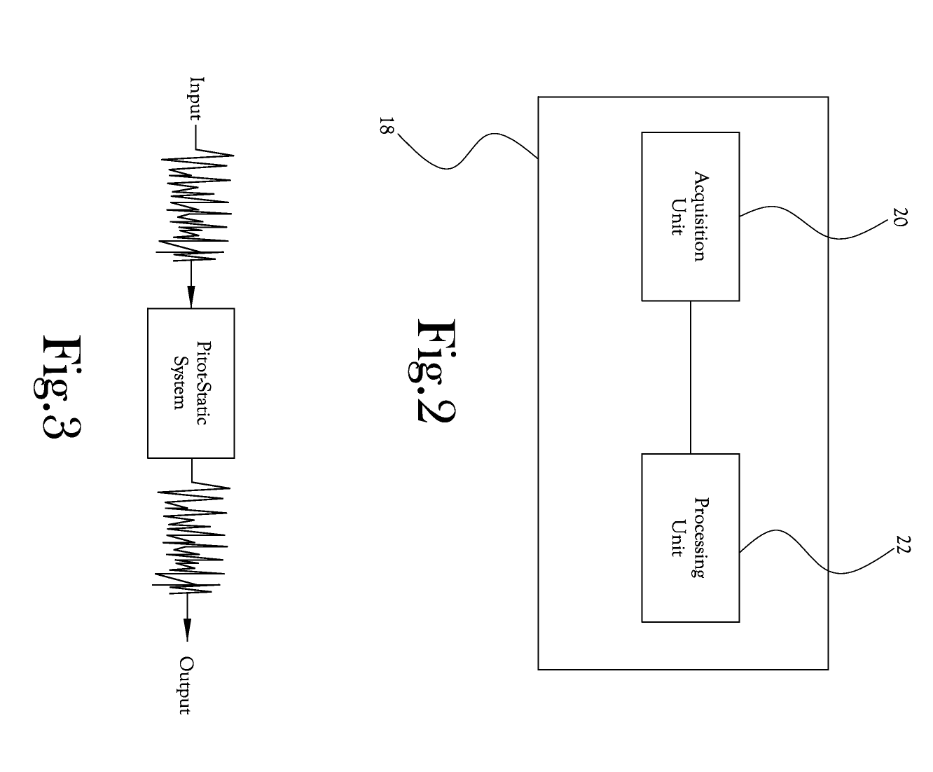

FIG. 2 is a block diagram of a pitot tube diagnostic system according to an example embodiment of the present general inventive concept. FIG. 2 illustrates a pitot tube diagnostic system illustrated generally at 18. The pitot tube diagnostic system 18 includes an acquisition unit 20 in communication with a processing unit 22. The acquisition unit 20 is configured to be placed in electrical communication with the pitot-static system 10 for the aircraft. The acquisition unit 20 samples the output signals from the pitot-static system 10 and produces sampled signals. The processing unit 22 receives the sampled signals from the acquisition unit 20 and performs filtering, calculations, and analysis on the sampled signals to determine the health of the pitot-static system 10.

FIG. 3 is a block diagram of a pitot-static system 10 and the respective input signal and output signal according to an example embodiment of the present general inventive concept. In the depicted embodiment, the input signal is representative of the air flow or pressure undergone by the pitot-static system 10 and the pitot-static system 10 produces an output signal responsive to the input signal. For the noise analysis technique proposed herein, the inherent fluctuations or noise from the sensor output arising from turbulence and process fluctuations are analyzed in the frequency domain. These fluctuations provide valuable indicators for failure detection when the sensor is subjected to a turbulent process. The output signal represents the sensor's response to the process fluctuations it is measuring, e.g., air flow or pressure.

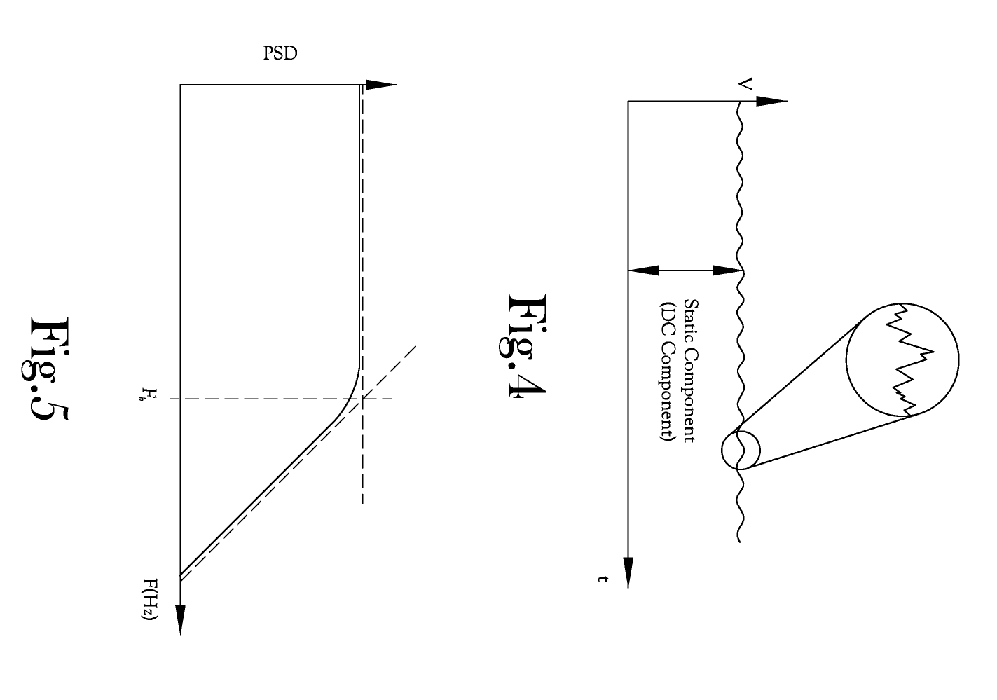

FIG. 4 is a representation of an electrical signal produced by the pitot-static system 10 including a static component and a dynamic component according to an example embodiment of the present general inventive concept. Specifically, the output signal of the pitot-static system 10 contains two components: a static (DC) component that represents the process parameter used by the pitot-static instruments 14 to provide airspeed, vertical speed or altitude, and a dynamic (AC) component that is a representation of the process fluctuations or “noise.” In one embodiment, the pitot tube diagnostic system 18 samples and filters the output signal to isolate the dynamic (AC) component. The Nyquist sampling theorem determines the appropriate data acquisition requirements to properly identify a pitot-static system dynamic response using the noise analysis technique. This theorem states that one has to acquire data at a frequency two times greater than the frequency one is trying to resolve. As an example, if the dynamic component of the pitot-static system contains meaningful data about its dynamic response at 100 Hz, then a minimum data sampling frequency of 200 Hz will be needed to adequately resolve this response using noise analysis.

FIG. 5 is an illustration of a theoretical PSD Curve with break frequency according to an example embodiment of the present general inventive concept. The power spectral density (PSD) signature of the data can be determined for the dynamic component of the pitot-static system 10 output signals. One method used to obtain these PSD signatures is called the “noise analysis” technique. Such a method can be utilized for detecting blockages of pressure sensors, which experience significant process fluctuations (noise). For example, the fluctuations from the sensor output arising from turbulence and process fluctuations can be analyzed in the frequency domain for evaluation of the pitot-static system 10. For frequency domain analysis, the Fast Fourier Transform (FFT) has proven to provide adequate results for performance monitoring and anomaly detection involving dynamic analysis of sensor outputs. FFT calculations of the signal “noise” are used to produce a Power Spectral Density (PSD) curve. The PSD is a variance of the signal amplitude (A2) in a narrow frequency band (Hz) that is normalized to frequency (A2/Hz), and then plotted against frequency. A PSD curve is used to determine a sensor's response time measured by the inverse of the break frequency (Fb) as shown in FIG. 5. As the pitot-static system 10 becomes impaired or degraded, the PSD curve display resonances or deviations from a PSD baseline curve.

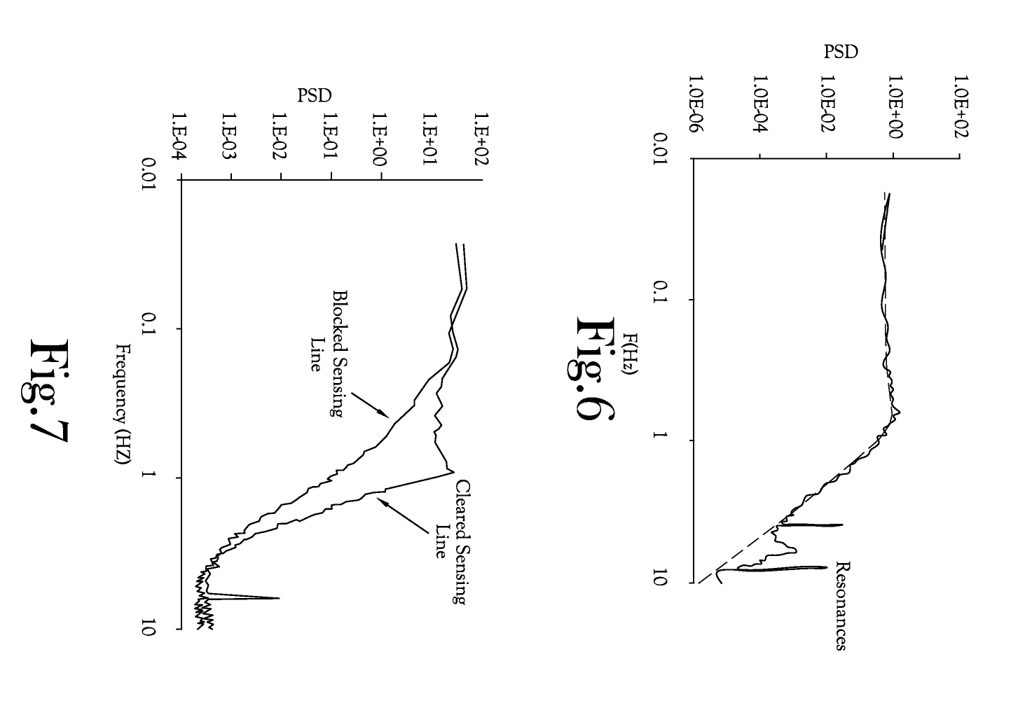

FIG. 6 is an illustration of a PSD curve showing resonance in the signal according to an example embodiment of the present general inventive concept. Typically, sensors are multi-order systems which may cause PSD curves to contain resonances.

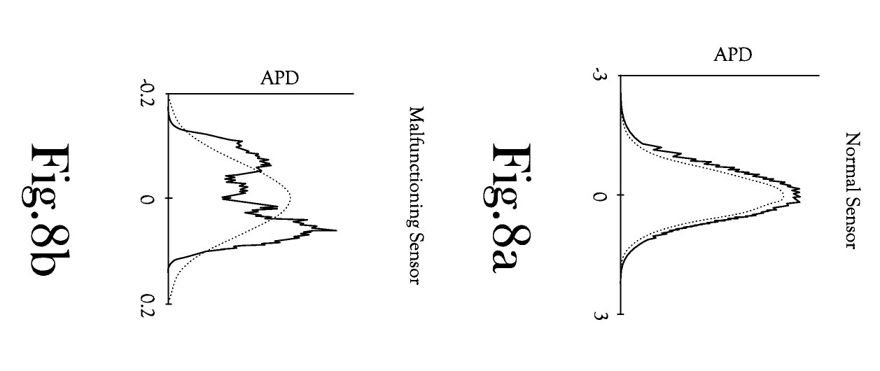

FIG. 7 is an illustration of the noise analysis results for a clear pitot tube and a blocked pitot tube according to an example embodiment of the present general inventive concept. More specifically, FIG. 7 illustrates the differences in two PSD curves for a pressure measurement through an unobstructed pitot tube and the same pressure measurement through a pitot tube containing a partial blockage. There is a significant decrease in dynamic response that indicates a blockage. Additionally, degradation in dynamic response can be characterized with the use of baseline comparison.

Furthermore, in one embodiment of the pitot tube diagnostic system 18, the data is qualified for evaluation of the pitot-static system 10. Raw data from the pitot-static system 10 in many processes often contain extraneous effects and artifacts that must be removed in preparing the data for processing analysis. Data qualification techniques can be used to qualify pitot-static system 10 output for noise analysis. The raw data can be screened for linearity, normality, and the presence of erroneous data records such as spikes. In this process, the mean value of the raw signal can be identified and examined block by block, the amplitude probability density (APD) plot of the data is generated, and data qualification parameters such as variance, skewness, and kurtosis are calculated and examined.

FIG. 8 illustrates two APD plots for a normal and an anomalous data record, namely FIGS. 8a and 8b, respectively. Specifically, FIGS. 8a and 8b are illustrations of APD plots for determining data quality and sensor performance according to an example embodiment of the present general inventive concept. These APD plots are used for detection of anomalies and for determining problems in the data itself. For a baseline reference, a Gaussian distribution function (the dashed bell-shaped curve) is also shown in FIGS. 8a and 8b. The illustrated Gaussian distribution curve provides the basis for determining the normality and linearity of the measured signal. The degree of abnormality of the data can be calculated by subtracting the APD from the corresponding Gaussian distribution.

In alternate embodiments, the pitot tube diagnostic system 10 can perform noise analysis on the data using other plotting and/or mathematical tools. For example, in one embodiment, the pitot tube diagnostic system 10 evaluates the dynamic component using Auto Regressive (AR) modeling. AR modeling allows the pitot tube diagnostic system to perform diagnostics autonomously. For example, the AR technique can be programmed to perform its function automatically using a computer. This is in contrast with PSD analysis which typically requires the analyst to look at the PSD plot and make a judgment. In another embodiment, the pitot tube diagnostic system 10 evaluates for blockages by performing zero-cross calculations on the dynamic component. Zero-cross calculations allow the pitot tube diagnostic system 10 to monitor the number of times that the dynamic component crosses an average value per unit of time. When the dynamic component is isolated from the sampled signal, the average value is zero because the static signal, or the DC bias, is removed such that the dynamic component fluctuates around zero. It is also noted that pitot tube diagnostics, such as diagnostics of a blockage, can benefit from the calculation of skewness, kurtosis, and higher movements of the dynamic component.

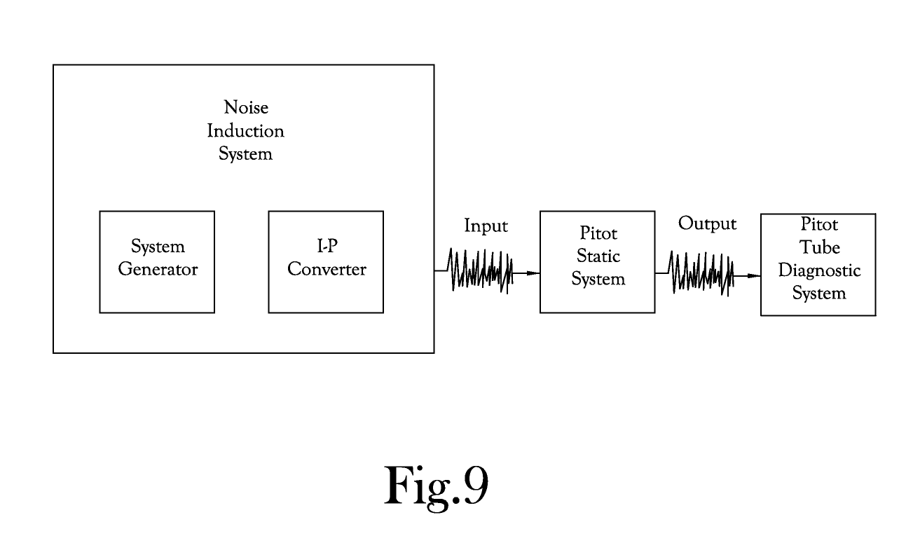

FIG. 9 is a block diagram of one embodiment of a system for performing pre-flight testing of pitot tubes according to an example embodiment of the present general inventive concept. Specifically, pre-flight testing allows the pitot tube diagnostic system 18 to diagnose the health of the instruments by detection of anomalies in pitot-static system 10. A fundamental premise of noise analysis is that the sensor, under test, will experience wideband process fluctuations to produce sufficient output for the technique. When an aircraft is in flight, pitot tubes should experience adequate high frequency fluctuations as a result of air speed, turbulence, etc. However, in pre-flight checks, the pitot tubes reside in mild conditions. Diagnosing pitot-static system 10 anomalies in pre-flight conditions requires inducing an input on the pitot-static system 10 and analyzing the resultant output using the same noise analysis technique. Referring to FIG. 9, the noise induction system uses a current to pressure (I-to-P) converter and a random signal generator. The signal generator provides the electrical signal that drives the I-to-P converter to produce a random pressure signal which is directed to the pitot tube under test. This approach simulates the airflow input to the pitot sensor that is used for the noise analysis technique. This noise induction method provides the benefit of diagnosing any issues in the pitot tube prior to takeoff to avoid costly delays.

From the forgoing description, it will thus be evident that the pitot tube diagnostic system 18 offers advantages for the detection of anomalies such as blockage, icing or moisture in aircraft pitot-static systems 10. The pitot tube diagnostic system 18 does not add significant weight or cost to current aircraft designs and can be implemented quickly and safely. Additionally, through the implementation of on-line monitoring for pitot tube blockage, flight delays due to instrumentation error as well as in-flight uncertainty and confusion could be reduced resulting in significant cost savings and improved reliability. Ultimately, the pitot tube diagnostic system 18 benefits the aviation industry, protects the public from aviation mishaps, and responds to current and long-term needs in the area of instrumentation failure detection, condition monitoring, and autonomous detection of anomalies for aircraft.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A pitot tube diagnostic system comprising:
a data acquisition unit to sample output signals of a pitot-static system; and
a processing unit to filter said sampled output signals to isolate a dynamic component of said sampled output signal and to monitor said dynamic component over time to diagnose the health of the pitot-static system.

2. The pitot tube diagnostic system of claim 1 wherein said processing unit diagnoses the health of said pitot-static system by analyzing said output signals of said pitot-static system for anomalies that indicate said pitot-static system is impaired, degraded, or blocked.

3. The pitot tube diagnostic system of claim 1 wherein said processing unit monitors said dynamic component over time by calculating a power spectral density curve for said dynamic component and monitoring said power spectral density curve against a baseline curve for the dynamic component.

4. The pitot tube diagnostic system of claim 1 wherein said processing unit calculates an amplitude probability density plot for said dynamic component and evaluates said amplitude probability density plot against a Gaussian distribution curve to measure the degree of abnormality of said dynamic component.

5. The pitot tube diagnostic system of claim 1 wherein said processing unit evaluates for blockages by calculation of skewness, kurtosis, and higher movements of said dynamic component.

6. The pitot tube diagnostic system of claim 1 wherein said processing unit evaluates the dynamic component by Auto Regressive (AR) modeling allowing said pitot tube diagnostic system to perform diagnostics autonomously without user interpretation.

7. The pitot tube diagnostic system of claim 1 wherein said dynamic component is evaluated using zero-cross calculations performed by said processing unit to monitor the number of times that the dynamic component crosses an average value per unit of time.

8. The pitot tube diagnostic system of claim 1 wherein said processing unit applies a low-pass filter to said sampled output signals to obtain said dynamic component in said sampled output signals.

9. The pitot tube diagnostic system of claim 1 wherein said processing unit qualifies the sampled output signals by screening said sampled output signals for linearity, normality, and the presence of erroneous data records by identifying and examining a mean value of said output signals of said pitot-static system against a baseline value.

10. The pitot tube diagnostic system of claim 1 wherein said processing unit qualifies said sampled output signals by screening the sampled output signals for linearity, normality, and the presence of erroneous data records by generating an amplitude probability density plot and calculating and examining the data qualification parameters including variance, skewness, and kurtosis to determine the degree of abnormality of said dynamic component.

11. A method for diagnosing the health of a pitot-static system during pre-flight inspections, comprising:
generating a random pressure signal;
directing said random pressure signal to the pitot-static system;
sampling output signals of said pitot-static system generated by said pitot-static system in response to said random pressure signal;
filtering said sampled output signals to isolate a dynamic component of said sampled output signals; and
monitoring said dynamic component to diagnose the health of said pitot-static system in pre-flight inspections.

12. The method for diagnosing the health of a pitot-static system of claim 11 wherein the operation of monitoring said dynamic component to diagnose the health of said pitot-static system includes determining whether said pitot-static system is impaired, degraded, or blocked.

13. The method for diagnosing the health of a pitot-static system of claim 11 wherein the operation of monitoring the dynamic component to diagnose the health of said pitot-static system in pre-flight inspections includes:
calculating a power spectral density curve for the dynamic component; and
evaluating the power spectral density curve for deviations from a baseline curve for the dynamic component.

14. The method for diagnosing the health of a pitot-static system of claim 13 further including the operation of:
performing the fast Fourier transform on the dynamic component to produce said power spectral density curve representing response time for the dynamic component.

15. The method for diagnosing the health of a pitot-static system of claim 13 wherein the operation of monitoring the dynamic component to diagnose the health of said pitot-static system further includes monitoring the power spectral density curve for deviations from a baseline comparison that is indicative of blockage.

16. The method for diagnosing the health of a pitot-static system of claim 11 wherein the operation of monitoring the dynamic component to diagnose the health of said pitot-static system further includes:
calculating an amplitude probability density plot for said dynamic component; and
evaluating said amplitude probability density plot against a Gaussian distribution curve to measure the degree of abnormality of said dynamic component.

17. The method for diagnosing the health of a pitot-static system of claim 11 wherein the operation of monitoring the dynamic component to diagnose the health of said pitot-static system further includes:
calculating of skewness, kurtosis, and higher movements of said dynamic component.

18. The method for diagnosing the health of a pitot-static system of claim 11 wherein the operation of monitoring the dynamic component to diagnose the health of said pitot-static system further includes:
monitoring said dynamic component by Auto Regressive (AR) modeling.

19. The method for diagnosing the health of a pitot-static system of claim 11 wherein the operation of monitoring the dynamic component to diagnose the health of said pitot-static system further includes:
using zero-cross calculations to monitor the number of times that the dynamic component crosses an average value per unit of time.

20. A pitot tube diagnostic system installed to a pitot-static system of an aircraft comprising:
a data acquisition unit to sample sensor output signals of said pitot-static system during flight of the aircraft; and
a processing unit to filter said sampled output signals to isolate a dynamic component of said sampled output signal and to monitor said dynamic component over time to diagnose the health of said pitot-static system.

21. The pitot tube diagnostic system of claim 20 wherein said processing unit diagnoses the health of said pitot-static system by analyzing said output signals of said pitot-static system for anomalies that indicate said pitot-static system is impaired, degraded, or blocked.

22. The pitot tube diagnostic system of claim 20 wherein said processing unit monitors said dynamic component over time by calculating a power spectral density curve for said dynamic component and monitoring said power spectral density curve against a baseline curve for the dynamic component.

23. The pitot tube diagnostic system of claim 20 wherein said processing unit calculates an amplitude probability density plot for said dynamic component and evaluates said amplitude probability density plot against a Gaussian distribution curve to measure the degree of abnormality of said dynamic component.

24. The pitot tube diagnostic system of claim 20 wherein said processing unit evaluates for blockages by calculation of skewness, kurtosis, and higher movements of said dynamic component.

25. The pitot tube diagnostic system of claim 20 wherein said processing unit evaluates the dynamic component by Auto Regressive (AR) modeling allowing said pitot tube diagnostic system to perform diagnostics autonomously without user interpretation.

26. The pitot tube diagnostic system of claim 20 wherein said dynamic component is evaluated using a zero-cross calculation performed by said processing unit to monitor the number of times that the dynamic component crosses an average value per unit of time.

27. The pitot tube diagnostic system of claim 20 wherein said processing unit applies a low-pass filter to said sampled output signals to obtain said dynamic component in said sampled output signals.

28. The pitot tube diagnostic system of claim 20 wherein said processing unit qualifies the sampled output signals by screening said sampled output signals for linearity, normality, and the presence of erroneous data records by identifying and examining a mean value of said output signals of said pitot-static system against a baseline value.

29. The pitot tube diagnostic system of claim 20 wherein said processing unit qualifies said sampled output signals by screening the sampled output signals for linearity, normality, and the presence of erroneous data records by generating an amplitude probability density plot and calculating and examining the data qualification parameters including variance, skewness, and kurtosis to determine the degree of abnormality of said dynamic component.
